(19) United States
(12) Patent Application Publication
(10) Pub. No.: US 2016/0192683 A1
(43) Pub. Date: Jul. 7, 2016

(54) ALLERGEN-FREE AND VEGETABLE-BASED FOOD PRODUCTS AND METHODS FOR PRODUCING AND THE SAME

(71) Applicant: Alimentum, LLC, Sharon, MA (US)

(72) Inventor: Susan Arnoff, Sharon, MA (US)

(21) Appl. No.: 14/989,347

(22) Filed: Jan. 6, 2016

Related U.S. Application Data
(60) Provisional application No. 62/100,200, filed on Jan. 6, 2015.

(51) Int. Cl. A23L 1/214

(52) U.S. Cl. CPC A23L 1/2142; A23L 1/214; A23V 2002/00

(57) ABSTRACT

Described herein are food products and methods for producing the same. In one aspect, the food products comprise one or more root vegetables. Also described are methods for producing food products comprising shredding a root vegetable, exposing the shredded root vegetable to a heated environment for a sufficient time to allow the shredded root vegetable to caramelize and/or dry, cooling the dried root vegetable, and combining the cooled, dried root vegetable with one or more other ingredients, such as seeds, coconut, salt or combinations thereof to form a food product. The food products described herein are substantially free from one or more common food-based allergens (e.g., gluten).

### RELATED APPLICATION

The present application claims priority to Provisional Application No. 62/100,200, entitled “Allergen-Free And Vegetable-Based Food Products And Methods For Producing And The Same,” filed on Jan. 6, 2015. This application incorporates the content of the provisional application by reference in its entirety.

### BACKGROUND

Food allergies are a common and potentially a serious and life-threatening problem in many individuals. Researchers estimate that up to 15 million Americans have food allergies. Also, approximately 1 out of every 13 children in the United States suffer from food allergies. According to a study by the Centers for Disease Control and Prevention (CDC), food allergies increased 50% among children from 1997 to 2011. The CDC has also reported that food allergies result in over 300,000 visits each year among children under the age of 18.

A food allergy is an immune reaction that occurs soon after eating a certain food. Immune reactions can include tingling or itching in the mouth, hives, itching, eczema, swelling of the lips, face, tongue and/or throat, wheezing or difficulty breathing, abdominal pain, nausea, vomiting, diarrhea, and in severe cases, anaphylaxis. Symptoms of anaphylaxis include constriction and tightening of the airways, swollen throat, shock, hypotension, tachycardia, dizziness, lightheadedness, and/or loss of consciousness. Approximately 90% of food allergies stem from shellfish, peanuts, tree nuts, fish, eggs, milk, and wheat (sometimes collectively referred to as common food allergens). Food allergies affect both children and adults of all races, ethnicities, and can occur at any age.

In addition to food allergies, food intolerance is also problematic for many individuals. For example, approximately 33% of all people are lactose intolerant. About 75% of African-American, Jewish, Mexican-American, and Native American adults, and about 90% of Asian American adults are lactose intolerant. Lactose is a sugar found in dairy products. Lactose intolerance occurs when the small intestine fails to produce enough of the digestion enzyme lactase.

Although not a true food allergy, celiac disease or celiac sprue, is a genetic autoimmune disease that affects the small intestine and the manner in which food is absorbed. Typically, those individuals suffering from Celiac disease must avoid gluten, a protein composite found in wheat and related grains. Estimates vary, but anywhere from about 8 to about 20 million Americans currently suffer from a gluten sensitivity. Gluten sensitivity can exacerbate symptoms of other autoimmune diseases such as Crohn's disease, Lupus, Type I diabetes, irritable bowel disorder, and colitis. Individuals suffering from Celiac disease or are lactose intolerant are limited in their choices of food.

Thus, there remains a need for an allergen-free food, such as a gluten-free and/or dairy-free food product for both children and adults.

### SUMMARY

Described herein are food products comprising a root vegetable, e.g. a sweet potato and/or yam. The food products can also comprise one or more additional ingredients. Also described herein are methods for producing the food products. The food products can be free from one or more allergens, such as, gluten, lactose, and peanuts.

In one embodiment, the invention relates to a method for producing a food product. The method for producing the food product comprises shredding a root vegetable, exposing the shredded root vegetable to a heated environment at a temperature of about 250° F. to about 300° F. (e.g, in an oven) for a sufficient time to allow the shredded root vegetable to dry, caramelize, or both. The method can further comprise allowing air at about room temperature to mix with the heated environment, while maintaining the temperature of about 250° F. to about 300° F. The method further comprises cooling the dried root vegetable to about room temperature. The method further comprises combining the cooled, dried root vegetable with one or more seeds, coconut, salt, or combinations thereof, to form the food product.

By way of example, the root vegetable is a monocotyledon, a dicotyledon, or a combination thereof. In one embodiment, the monocotyledon is a yam. In another embodiment, the dicotyledon is a sweet potato. In another embodiment, the root vegetable is a yam and a sweet potato. For example, types of sweet potatoes and yams that can be used in the food products and methods described herein, include, but are not limited to, Murasaki, Japanese, Oriental, Yellow Jersey, Hanna, Satsumi-imo sweet potato, white haymon sweet potato, Boniato sweet potato, Kokoro, purple yam, Chinese yam/Cinnamon yam, Kotobuki, Satsuma, Sumor, Okinawan purple, Japanese mountain yam, cush-cush yam, the lesser yam, Yamiamo, Chiwoko, Amelia, Carrot C, Delvia, Ejumula, Kakame Ga, Persistente, RW 11-2910, UMUSPO/1, Mayai, and Naspot.

The dried root vegetable can have a density of about 0.5 g/ml to about 1.5 g/ml. For example, the dried root vegetable has a density of about 1.1 g/ml.

The food product can also include other ingredients, such as one or more sugar or sugar substitutes. By way of example, the one or more sugar or sugar substitutes can comprise stevia, agave syrup, and/or a coconut sugar. Another ingredient that can be added is one or more oils, such as sunflower oil. Another ingredient that can be added are seeds such as sunflower seeds, a pumpkin seeds, or a combination thereof. One or more fruits can also be added as another ingredient to the food products described herein. The fruit can be dried to increase shelf-life and preservation. Examples include, cranberries, raisins, coconut or a combination thereof.

Another ingredient that can be added to the food products of the present invention is cacao. For example, chocolate is added to the food products.

The method for producing a food product according to the present teachings can include shredding the root vegetable, for example, by passing the root vegetable through a shredding plate. In some embodiments, the shredding plate comprises holes from about ⅙ of an inch to about ½ of an inch in diameter. In some embodiments, the shredding plate comprises holes about 3/16 of an inch in diameter.

The root vegetable can be shredded into one or more strands of about 1 inch to about 3 inches in length. The shredded root vegetable can be layered from about ⅛ of an inch to about 1 inch on a baking sheet or pan prior to the exposing it to a heated environment.

The method of exposing the shredded root vegetable to a heated environment of about 250° F. to about 300° F. further comprises allowing air at about room temperature to mix with the heated environment. Allowing room temperature air to mix with the heated environment can aid in the drying and/or caramelization of the root vegetable. The heated environment can be maintained at about 250° F. to about 300° F. The circulating air at room temperature has a temperature of about 50° F. to about 90° F. and/or a humidity of less than about 70%.

The methods of the present invention can also include protecting the root vegetable from oxidation.

In a related aspect, a food product is disclosed, which is prepared according to the aforementioned methods. In some embodiments, the food product is substantially gluten-free. In some embodiments, the food product is substantially nut-free. In some embodiments, the food product is substantially gluten-free and nut-free. In some embodiments, the food product is packaged.

### BRIEF DESCRIPTION OF FIGURES

FIG. 1 is a flow chart illustrating one embodiment of the method for producing a food product.

FIG. 2A is a top view of one embodiment of the processed root vegetables.

FIG. 2B is a perspective view of one embodiment of processed root vegetables.

FIG. 3A is a top view of one embodiment of the processed, exposed, and cooled root vegetables.

FIG. 3B is a perspective view of one embodiment of the processed, exposed, and cooled root vegetables.

FIG. 4 illustrates a sweet potato (white sweet potato) used in embodiments described herein.

FIG. 5 illustrates one embodiment of caramelized sweet potatoes.

FIG. 6 illustrates starched (scorched) shredded sweet potato strands.

FIG. 7 illustrates a flour or a powdered-like product of the dried and caramelized root vegetable.

FIG. 8 illustrates a shredded root vegetable which has oxidized for approximately 9-15 hours at 60-75° F.

FIG. 9 illustrates thinly sliced, baked, lightly salted and oiled, root vegetable.

FIG. 10 illustrates shredded root vegetable, which has been shredded using a shred plate containing holes approximately ¼ to ¾ inches in diameter.

FIG. 11A illustrates freshly shredded sweet potato.

FIG. 11B illustrates sweet potato discoloration when exposed to air.

FIG. 12 illustrates baked, shredded sweet potato.

FIG. 13 is a photograph of a desired color of the resulting food product side by side with an undesired color.

FIG. 14A illustrates baked, shredded sweet potato in bar form.

FIG. 14B illustrates baked, shredded sweet potato in muffin form.

FIG. 15 illustrates a one embodiment of shredded (unbaked and baked) sweet potato based food product in cereal form.

### DETAILED DESCRIPTION

The invention described herein relates to food and food products comprising a root vegetable. Also described are methods for producing the food products comprising a root vegetable. Those skilled in the art will understand that the food products and the methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present invention.

The present invention relates to a food product comprising a root vegetable and one or more additional ingredients. The one or more additional ingredients can be any combination of one or more seeds, a coconut, a sugar or a sugar substitute, an oil, a fruit, and salt. The root vegetable, for example, can be a sweet potato and/or a yam. The root vegetable is processed so that it is dried, caramelized, or a combination thereof.

The present invention also relates to a method for producing a food product. The method includes processing a root vegetable, such as by shredding the root vegetable. The method also comprises exposing the shredded root vegetable to a heated environment (e.g., in an oven) maintained at a temperature of about 250° F. to about 300° F. for a sufficient time to allow the shredded root vegetable to dry and/or caramelize. The method includes allowing air at about room temperature to mix with the heated environment. The air at about room temperature can have a temperature of about 50° F. to about 80° F., a humidity of less than about 70%, or a combination thereof.

The dried root vegetable is cooled, e.g., to about room temperature. The method includes combining the cooled, dried root vegetable with one or more other ingredients, such as seeds, coconut, salt, or combinations thereof, to form the food product.

As used herein, the terms “about” or “approximately” for any numerical values or ranges indicate a suitable dimensional tolerance that allows the composition, part, or collection of elements to function for its intended purpose as described herein. These terms indicate at most a ±5% variation about a central value.

The food products and methods according to the present invention comprise a root vegetable. For example, the root vegetable is any one of the known species of root vegetables. Suitable root vegetables include, but is not limited to true roots, e.g., tuberous roots and taproots, and non-roots, e.g., tubers, rhizomes, corms and bulbs.

A true root vegetable can be a taproot and/or a tuberous root. Examples of taproots include, but are not limited to, Arracacia xanthorrhiza (arracacha), Abelmoschus moschatus(bush carrot), Beta vulgaris (beet and mangelwurzel), Brassica spp. (rutabaga and turnip), Bunium persicum (black cumin), Burdock (Arctium, family Asteraceae), Carrot (Daucus carota subsp. sativus), Celeriac—(Apium graveolens rapaceum), Daikon—the large East Asian white radish (Raphanus sativus var. longipinnatus), Dandelion—(Taraxacum) spp., Lepidium meyenii (maca), Microseris scapigera (yam daisy), Pachyrhizus spp. (jicama and ahipa), Parsnip (Pastinaca sativa), Petroselinum spp. (parsley root), Radish—(Raphanus sativus), Scorzonera hispanica (black salsify), Sium sisarum (skirret), Tragopogon spp. (salsify), and Vigna lanceolata (bush potato).

Examples of tuberous roots include, but are not limited to Amorphophallus galbra (Yellow lily yam), Conopodium majus (pignut or earthnut), Dioscorea opposita (nagaimo, Chinese yam, Korean yam), Hornstedtia scottiana (Native ginger), Ipomoea batatas (sweet potato), Ipomoea costata (desert yam), Manihot esculenta (cassava or yuca or manioc), Mirabilis extensa (mauka or chago), Psoralea esculenta (breadroot, tipsin, or prairie turnip), and Smallanthus sonchifolius (yacón).

An example of a root vegetable comprising a root-like stem is a Zamia pumila(Florida arrowroot).

A non-root comprises a tuber, a rhizome, a corm and/or a bulb. Examples of corm include, but are not limited to, Amorphophallus konjac (konjac); Colocasia esculenta (taro); Eleocharis dulcis (Chinese water chestnut); Ensete spp. (enset); Nelumbo nucifera; Nymphaea spp. (waterlily); Pteridium esculentum; Sagittaria spp. (arrowhead or wapatoo); Typha spp.; Xanthosoma spp. (malanga, cocoyam, tannia, and other names);

Examples of rhizomes include, but are not limited to, Curcuma longa (turmeric); Panax ginseng (ginseng); Arthropodium spp. (rengarenga, vanilla lily, and others); Canna spp. (canna); Cordyline fruticosa (ti); Maranta arundinacea (arrowroot); Nelumbo nucifera (lotus root); Typha spp. (cattail or bulrush); Zingiber officinale (ginger, galangal);

Examples of tubers include, but are not limited to, Apios americana (hog potato or groundnut); Cyperus esculentus (tigernut or chufa); Dioscorea spp. (yams, ube); Helianthus tuberosus (Jerusalem artichoke or sunchoke); Hemerocallis spp. (daylily); Lathyrus tuberosus (earthnut pea); Oxalis tuberosa (oca or New Zealand yam); Plectranthus edulis and P. esculentus (kembili, dazo, and others); Solanum tuberosum (potato); Stachys affinis (Chinese artichoke or crosne); Tropaeolum tuberosum (mashua or añu); and Ullucus tuberosus (ulluco).

Examples of bulbs include, but are not limited to, Allium spp. (garlic, onion, shallot, leek, etc.); Camassia quamash (quamash); Cyperus bulbosus (bush onion); Caladenia; Cryptostylis; Cymbidium canaliculatum; Diuris; Dipodium; Erythronium spp. (katakuri); Foeniculum vulgare (fennel); Geodorum; Glossodia; Lilium spp. (lilies); Lypernathus; Microtis; Prasophyllum; Pterostylis; Tacca leontopetaloides; and Thelymitra.

Root vegetables can vary in their nutritional content, e.g., carbohydrate composition. For example, tubers can contain more starch than a true root vegetable, which can contain more simple sugars. Both true roots and non-roots are sources of other vitamins, minerals and other nutrients, such as fiber, potassium, vitamin A, calcium, vitamin B6, vitamin C, biotin, vitamin B1, vitamin B2, vitamin B3, iron, copper and magnesium.

Suitable root vegetable used in the food products can be a monocotyledon, a dicotyledon, or a combination thereof. Examples of a monocotyledon (“monocot”) include a yam, such as a White Yam, Yellow Yam, Kokoro, Japanese Mountain Yam, Purple yam, Jicama, Malanga, or combinations thereof.

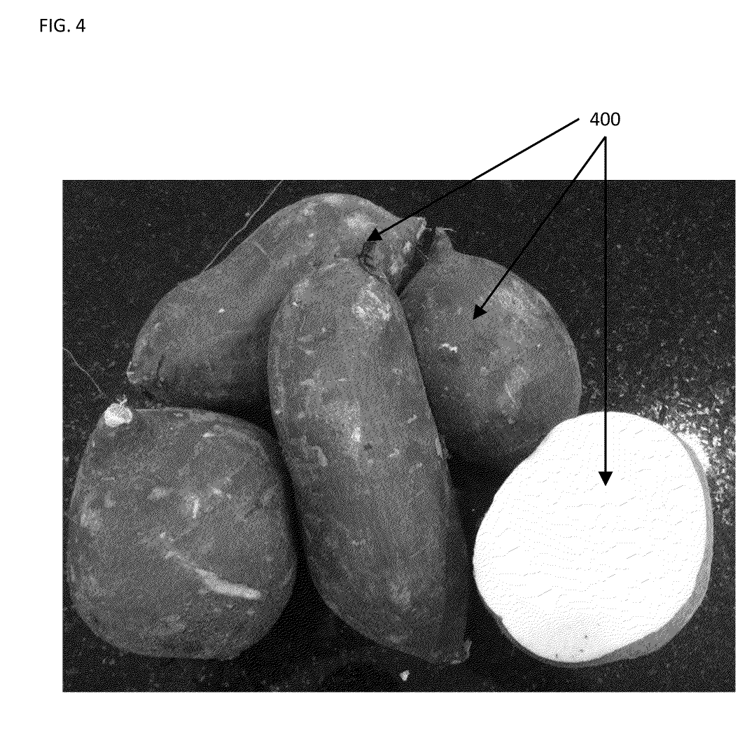

Examples of a dicotyledon include a sweet potato, a Batas, Brazilian sweet potatoes, Dingess sweet potatoes, Japanese Purple sweet potatoes, Okinawan sweet potatoes, Mokuau sweet potatoes, Covington sweet potatoes, Beureagarde sweet potatoes, Carolina Ruby sweet potatoes, Murasaki-29, Tai-Nung No. 2, and other Japanese and Oriental varietals. FIG. 4 is a photograph a white sweet potato.

The food products described herein can have, for example, one or more types of root vegetables. For example, the food products can have a yam and a sweet potato. In some embodiments, the food products have 1, 2, 3, 4, 5, 6, 7, 8, 9, 10 or more different types of root vegetables. Table 1, below, lists examples of sweet potatoes, characterized by their flesh color.

TABLE 1
Types of Sweet Potatoes

| Orange-fleshed | Purple-fleshed | White-fleshed |
|---|---|---|
| Beuregarde | Agena | Batas |
| California Gold | Japanese Purple | Brazilian |
| Carolina Ruby | Korean Purple | Dingess |
| Covington | Mokuau | Hayman |
| Evangeline | Okinawan | O'Henry |
| Gold Nugget | Purple | Uyentan |

Other suitable root vegetables for the methods and food products described herein have a lower water content, a lower sugar content, a higher starch content, or a combination thereof compared to other root vegetables. The root vegetable water content, can be, for example, less than 80%, less than 70%, less than 60%, or less than 50%.

For example, these characteristics (e.g., low water content and high starch content) can be found in many types of sweet potatoes and yams and can be used in the food products and methods described herein. These sweet potatoes and yams include, but are not limited to, Murasaki, Japanese, Oriental, Yellow Jersey, Hanna, Satsumi-imo sweet potato, white haymon sweet potato, Boniato sweet potato, Kokoro, purple yam, Chinese yam/Cinnamon yam, Kotobuki, Satsuma, Sumor, Okinawan purple, Japanese mountain yam, cush-cush yam, the lesser yam, Yamiamo, Chiwoko, Amelia, Carrot C, Delvia, Ejumula, Kakame Ga, Persistente, RW 11-2910, UMUSPO/1, Mayai, and Naspot.

Any combination of root vegetables, along with other ingredients, can be used to prepare a food product with a certain taste, color, appearance, and/or nutritional content.

One or more sugar or sugar substitutes can be combined with the cooled, dried root vegetable to form the food product. As used herein, a “sugar” refers to any natural or synthetic sugar, i.e., any short-chain carbohydrate. As used herein, a “sugar substitute” refers to any food additive sweetener. That is, sugar substitutes can have little to no effect on an individual's blood glucose. For example, the one or more sugar or sugar substitutes is stevia, agave syrup, a coconut sugar, or a combination thereof. Other examples of a sugar or sugar substitute can include, but is not limited to, white sugar, extra fine sugar, fine sugar, superfine sugar, ultrafine sugar, raw sugar, fruit sugar, bakers sugar, confectioners' sugar, powdered sugar, coarse sugar, sanding sugar, brown sugar, turbinado sugar, evaporated cane sugar, muscovado sugar, Barbados sugar, demerara sugar, sucrose, glucose, fructose, stevia, aspartame, sucralose, neotame, acesulfame potassium, saccharin, advantame, sorbitol, xylitol, agave syrup, cane syrup, and maple syrup. Other examples of a sugar or sugar substitute includes honey, maple syrup, coconut palm sugar, luo han guo, dates and date syrup, prunes and prune juice, brown rice syrup, Yacon Root Syrup, and palm sugar.

One or more oils can be combined with the cooled, dried root vegetable to form the food product. For example, one or more oils can include vegetable oil, olive oil, avocado oil, butter, ghee, canola oil, coconut oil, rice bran oil, corn oil, cottonseed oil, grape seed oil, hemp oil, lard, margarine, olive oil, palm oil, pumpkin seed oil, soybean oil, sunflower oil, fruit oil, and tea seed oil. Other examples of an oil can include safflower oil, canola oil, sesame oil, pumpkin seed oil, watermelon seed oil, gourd oil, grape seed oil, rape seed oil, apricot oil, argan oil, carob seed pod oil, amaranth oil, avocado oil, babassu oil, cohune oil, camelina sativa oil (false flax), flax oil, artichoke oil, blackcurrent seed oil, meadowfoam seed oil, perilla seed oil, and quinoa oil. The one or more oils described herein can also be any oil from a plant, seed, and/or kernel fit for human consumption.

Flavored oils can also be used in the food products described herein. By way of example, a flavored oil can comprise a cooking oil and at least one additive. An additive can be combined with the oil to provide an additional taste or flavor to the oil. For example, an additive can comprise any spice, herb, citrus, seed, extract (e.g., fruit extract), aromatic, or combinations thereof. For example, a flavored sunflower oil can be used in the food products.

The one or more oils comprises a fruit oil. A fruit oil can comprise the extract of an oil from any fruit, for example, from a fruit rind or seed.

One or more seeds can be used in the food products described herein. For example, the seeds can be a sunflower seed, a pumpkin seed, or a combination thereof. As used herein, a “seed” refers to any seed fit for consumption by an individual. Examples of other suitable seeds include, but are not limited to, chia seeds, flax seeds, hemp seeds, sesame seeds, apricot (kernels) seeds, pomegranate seeds, pine seeds, and papaya seeds. The one or more seeds described herein can also be any seed from a fruit and/or plant fit for consumption.

One or more fruits can be used in the food products described herein. In one embodiment, the one or more fruits is a dried fruit. In some embodiments, the fruit is a cranberry, a raisin, or a combination thereof. In another embodiment, for example, the fruit is an apple, apricot, avocado, banana, breadfruit, bilberry, blackberry, blackcurrant, blueberry, boysenberry, cantaloupe, currant, cherry, cherimoya, cloudberry, coconut, cranberry, cucumber, damson, date, dragonfruit, durian, eggplant, elderberry, feijoa, fig, goji berry, gooseberry, grape, raisin, grapefruit, guava, huckleberry, honeydew, jackfruit, jambul, jujube, kiwi fruit, kumquat, lemon, lime, loquat, lychee, mango, marion berry, melon, cantaloupe, honeydew, rock melon, miracle fruit, mulberry, nectarine, olive, orange, clementine, mandarine, blood orange, tangerine, papaya, passionfruit, peach, pepper, chili pepper, bell pepper, pear, williams pear, bartlett pear, persimmon, physalis, plum, prune (dried plum), pineapple, pomegranate, pomelo, purple mangosteen, quince, raspberry, western raspberry (blackcap), rambutan, redcurrant, salal berry, salmon berry, satsuma, star fruit, strawberry, tamarillo, tomato, ugli fruit, watermelon or a combination thereof.

Other food items (i.e., ingredients) can be added to the dried root vegetable to produce the food products as described herein. For example, the food product further comprises chocolate. In some embodiments, the chocolate is unsweetened chocolate, semisweet chocolate, bittersweet chocolate, dark chocolate, sweet dark chocolate, semisweet dark chocolate, dairy-free chocolate, cacao powder, or combinations thereof.

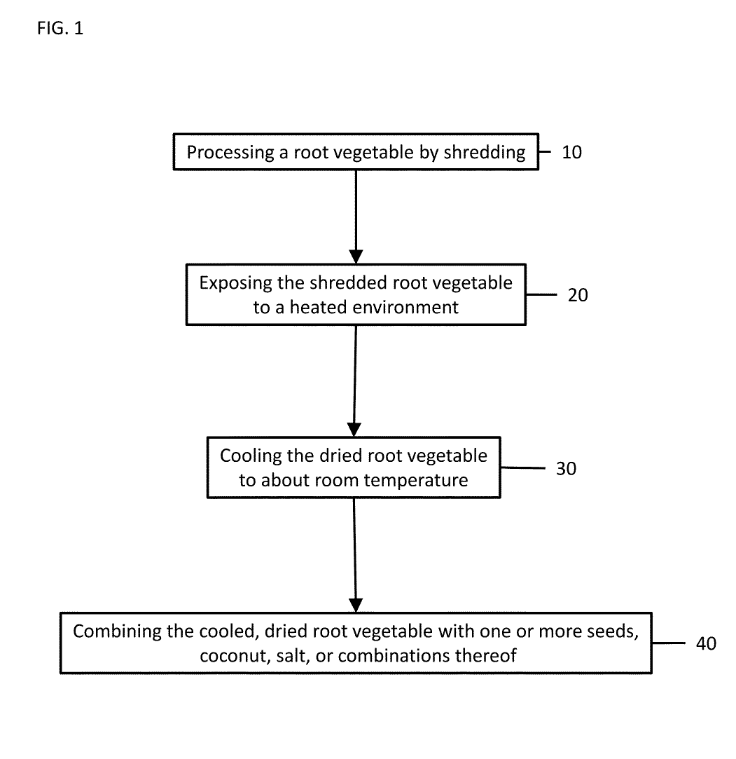

Referring to FIG. 1, the method for producing a food product which comprises processing a root vegetable by shredding the root vegetable (step 10), exposing the shredded root vegetable to a heated environment (step 20), cooling the dried root vegetable to about room temperature (step 30), and combining the cooled, dried root vegetable with one or more seeds, coconut, salt or combinations thereof to form a food product (step 40).

The heated environment step 20 is performed at an elevated temperature in a range of about 250° F. to about 300° F., for example, in an oven. In step 20, the shredded root vegetable is exposed to a heated environment for a sufficient time to allow the shredded root vegetable to dry. The heating in step 20 can also include allowing air at about room temperature to mix with the heated environment. Mixing room temperature air with the air in the heated environment maintains the elevated temperature at about 250° F. to about 300° F. This can be performed in a number of ways, for example, by slightly opening an oven door during the exposing step. For example, the oven door can be opened approximately 1 inch to allow room temperature air to mix with the heated environment. Also, the air at about room temperature can have a temperature of about 50° F. to about 80° F. and/or a humidity of less than about 70%.

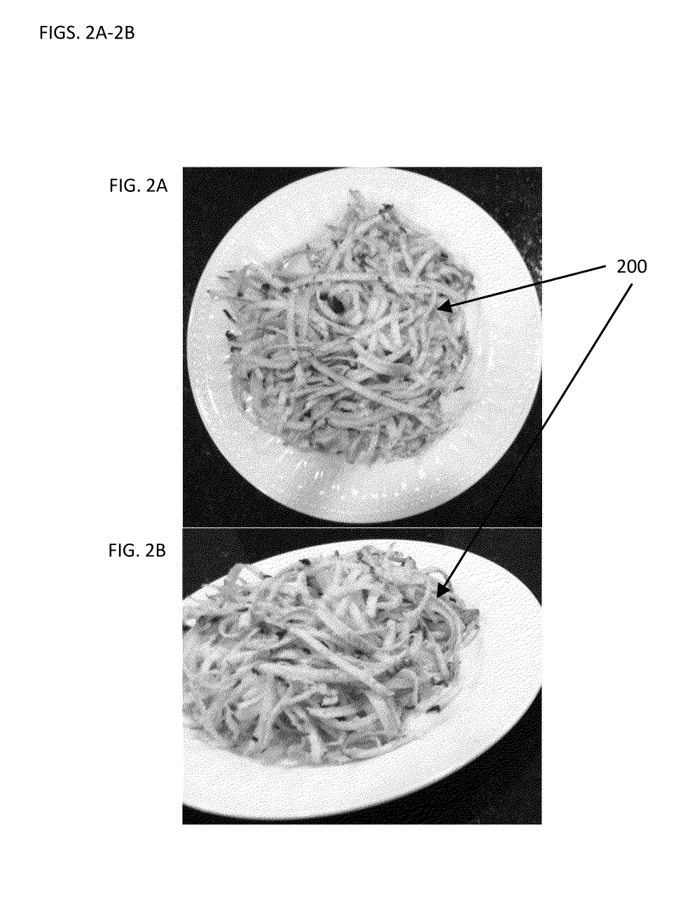

As described herein, the invention relates to a method for producing a food product, which comprises processing a raw, root vegetable (step 10). Processing the root vegetable can include shredding the root vegetable. As used herein, the term “shredding” refers to any method to produce smaller pieces, e.g., of a root vegetable. Such methods include cutting, grating, shaving, chopping, mincing, or tearing. For example, shredding a root vegetable can be performed by passing the root vegetable through a shredding plate. The shredding plate can have a plurality of holes, each about ⅙ inch to about ½ inch in diameter. The shredding plate can have a plurality of holes, each about 3/16 inch in diameter. Shredding the root vegetable produces a shredded root vegetable of one or more strands from about 1 inch to about 3 inches in length. For example, FIGS. 2A-2B, illustrates shredded root vegetable 200.

Processing the root vegetable can also include layering the shredded, raw root vegetable, e.g., on a baking sheet or pan. For example, the shredded root vegetable is layered about ⅛ to about 1 inch thick. Typically, the shredded root vegetable is layered on a baking sheet prior to the step of exposing it to a heated environment described herein.

Processing the root vegetable can also include protecting the shredded root vegetable from oxidation. The oxidation of food, e.g., root vegetables, can be prevented or slowed by storing the shredded root vegetable in a container. The container can be substantially air-tight and/or liquid tight. Other air-tight and/or liquid tight containers (systems), such as a vacuum sealed package can also be used. Other means of protecting from oxidation includes refrigerating and/or freezing the shredded root vegetable. Other means of protecting from oxidation includes submerging the shredded root vegetable in water until it is ready to be used.

The methods described herein include exposing the shredded, raw root vegetable to a heated environment for a sufficient time to allow the shredded root vegetable to dry (e.g., by baking). The heated environment can also allow the shredded root vegetable to caramelize. After sufficient time, the shredded root vegetable can be dried and caramelized. For example, the heated environment is maintained at a temperature in a range of about 250° F. to about 300° F., about 260° F. to about 290° F., or about 270° F. to about 280° F. The temperature is, for example about 250° F., about 260° F., about 270° F., about 280° F., about 290° F. or about 300° F.

Exposing the shredding root vegetable to a heated environment further can include allowing air to mix with the heated environment. For example, the temperature of the air is about room temperature, e.g., about 40° F. to about 100° F. By way of example, the air temperature can be about 40° F., about 50° F., about 60° F., about 70° F., about 80° F., about 90° F. or about 100° F.

Mixing room temperature air with the air in the heated environment results in a temperature as described herein, e.g., in a range of about 250° F. to about 300° F.

The air at room temperature can also have a humidity of less than about 70%. For example, the air at room temperature has a humidity of less than about 60%, less than about 50%, less than about 40%, less than about 30%, less than about 20%, or less than about 10%.

Exposure of the shredded root vegetable to a heated environment can be accomplished in a variety of different ways, e.g., baking the shredded root vegetable in an oven or any thermally insulated chamber. For example, types of ovens include convection ovens, gas ovens, stone ovens, ceramic ovens, wood-fired ovens, toaster ovens, and microwave ovens.

After exposure to the heated environment for a sufficient time to allow the shredded root vegetable to dry, the dried shredded root vegetable can have less than about 50% water (water per volume). For example, the dried shredded root vegetable can have less than about 40% water, less than about 30% water, less than about 20% water, less than about 10% water, or about 0% water.

Also, the time required to allow the shredded root vegetable to dry can be any amount of time such that the dried root vegetable contains a desired water content (or lack thereof), such as the amounts described herein. For example, in some embodiments, the time can be about 10 minutes to about 150 minutes. By way of example, the time to allow the shredded root vegetable to dry can be about 10 minutes, about 20 minutes, about 30 minutes, about 40 minutes, about 50 minutes, about 60 minutes, about 70 minutes, about 80 minutes, about 90 minutes, about 100 minutes, about 110 minutes, about 120 minutes, about 130 minutes, about 140 minutes, about 150 minutes or more than about 150 minutes. One of ordinary skill in the art can readily appreciate that there are a variety of factors that can determine the amount of time to reach a desired level of dryness (e.g., % water content). For example, temperature, humidity, elevation (above or below sea level), cooking process, type of root vegetable, initial water content, initial starch content, initial sugar content, and size of shredded root vegetable can each affect the time required for the root vegetable to reach a level of dryness. The time and the dried shredded root vegetable is typically be positively correlated, i.e., more time is required (in the heated environment) to reach a greater level of dryness (e.g., decreased water content).

The methods according to the present invention can result in a dried, shredded root vegetable that has a density of about 0.5 g/ml to 1.5 g/ml. For example, the dried root vegetable has a density of about 0.6 g/ml to about 1.4 g/ml, about 0.7 g/ml to about 1.3 g/ml, about 0.8 g/ml to about 1.2 g/ml, or about 0.9 g/ml to about 1.1 g/ml. The dried, shredded root vegetable can be about 0.5 g/ml, about 0.6 g/ml, about 0.7 g/ml, about 0.8 g/ml, about 0.9 g/ml, about 1.0 g/ml, about 1.1 g/ml, about 1.2 g/ml, about 1.3 g/ml, about 1.4 g/ml, or about 1.5 g/ml.

As illustrated in step 30 of FIG. 1, the shredded root vegetable is cooled after it has been dried. In one embodiment, the dried root vegetable is cooled to about room temperature. In one embodiment, the dried root vegetable is cooled to a temperature lower than about room temperature. For example, the dried root vegetable can be cooled to about 32° F. or about 0° F. Cooling the dried vegetable can comprise any method to lower the temperature of the dried root vegetable to the desired lower temperature. For example, the dried root vegetable can be placed on cooling racks, refrigerated, frozen, or combinations thereof.

A food product can be prepared according to the methods described herein. For example, the food product can be prepared by shredding a raw root vegetable (e.g., a yam and/or sweet potato), exposing (e.g., baking) the shredded root vegetable to a heated environment maintained at a temperature in a range of about 250° F. to about 300° F. for a sufficient time to allow the shredded root vegetable to dry, cooling the shredded root vegetable to about room temperature, and combining the cooled, dried root vegetable with one or more other ingredients, such as seeds, coconut, salt, or combinations thereof. In some embodiments, the root vegetable comprises a yam. In other embodiments, the root vegetable comprises a sweet potato. In other embodiments, the root vegetable comprises a yam and a sweet potato.

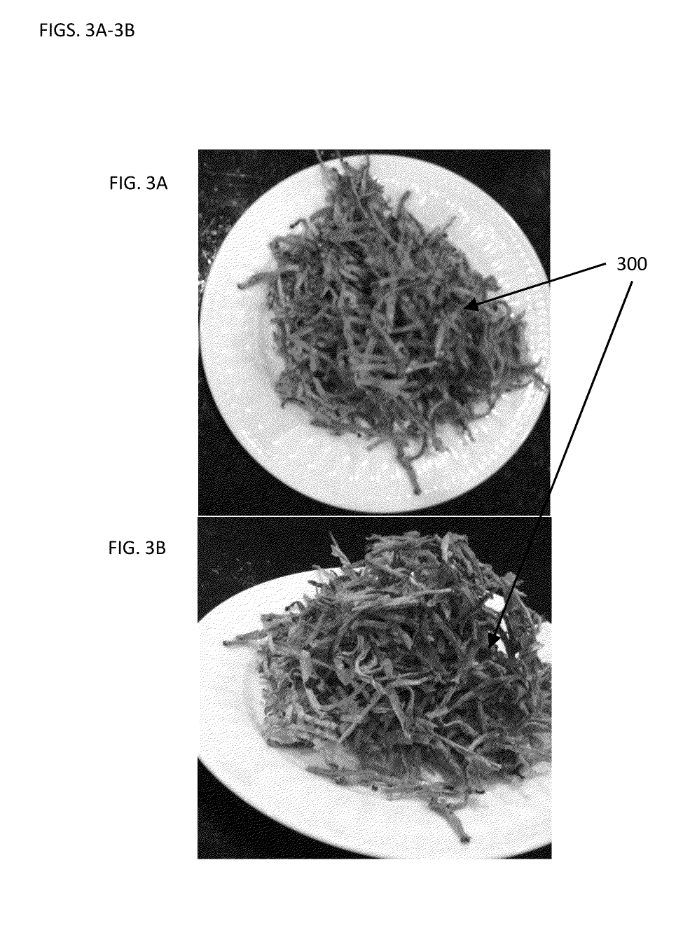

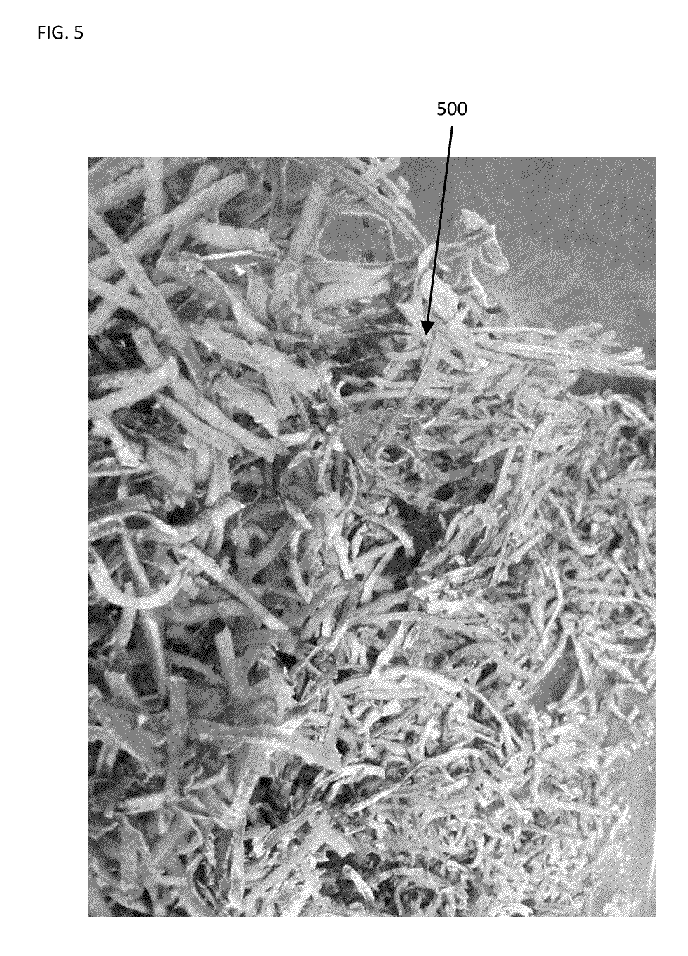

FIGS. 3A-3B illustrates a dried, shredded root vegetable (e.g., sweet potato) 300 after exposure to a heated environment for a sufficient time to dry and/or caramelize the sweet potato. As shown in FIGS. 3A and 3B, the exposure of the shredded root vegetable to a heated environment caramelizes the root vegetable 300. FIG. 5 is a photograph that illustrates a sweet potato 500 caramelized in accordance with the present teachings. The dried, caramelized root vegetable 500 is similar in appearance to the root vegetable 300 in FIG. 3.

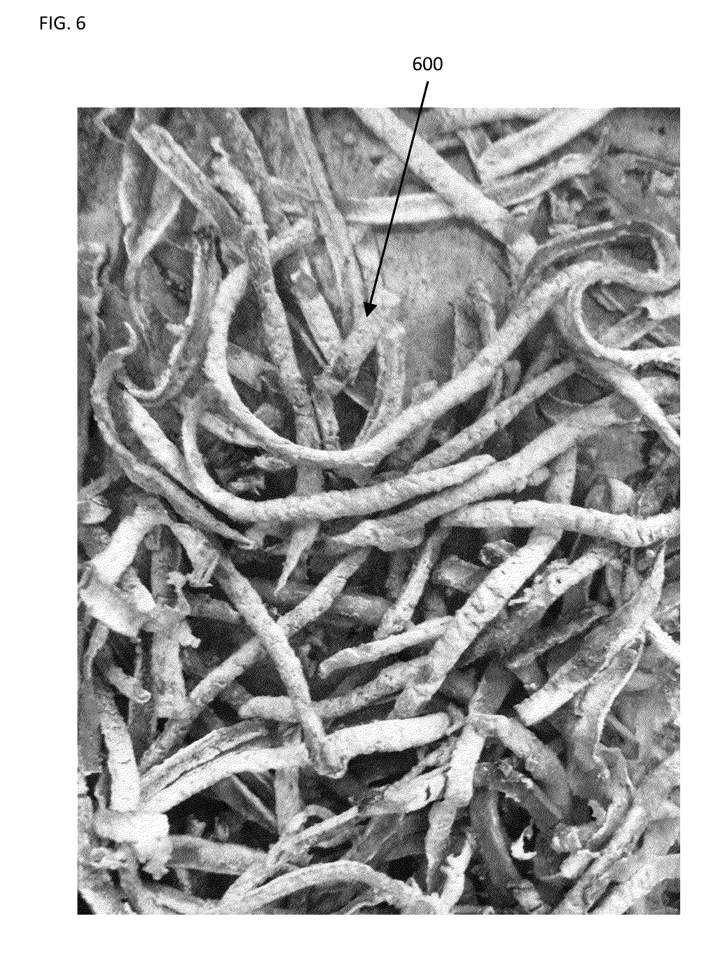

The methods described herein also prevent the root vegetable from becoming starched or other adverse effects from the baking process. FIG. 6 is a photograph of a starched (e.g., scorched) shredded sweet potato 600. Starching can be the result of sub-optimal processing of the root vegetable. It can also result in a root vegetable that loses its preferred color, flavor and taste. Any one of a number of factors can affect the root vegetable to become starched. For example, ambient conditions such humidity, temperature, and air flow can affect the root vegetable's ability to dry and caramelize.

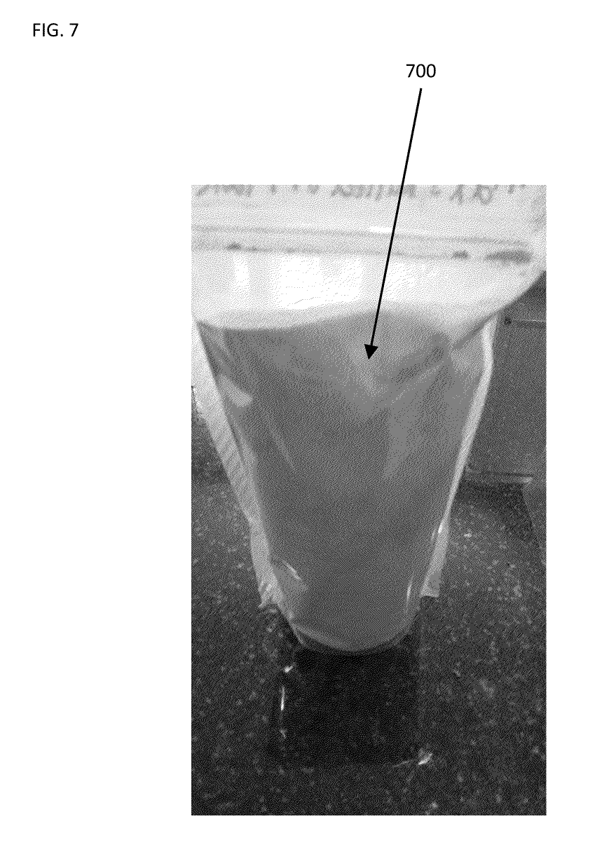

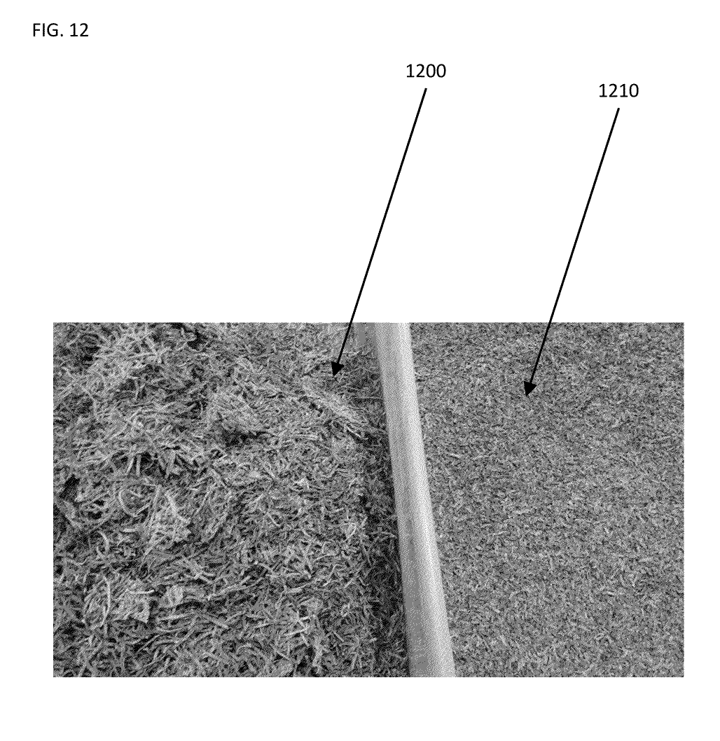

According to the methods of the present invention, the dried and/or caramelized shredded root vegetable is further processed to produce one or more food products. For example, the shredded root vegetable can be broken or processed into smaller pieces (e.g., using a food processor). For example, the smaller pieces can vary in size and shape. In some embodiments, the smaller pieces can be substantially uniform in size and shape. One of ordinary skill in the art will readily appreciate that the size and shape of the root vegetable can be tailored to a specific food product. For example, in some embodiments, the shredded root vegetable is broken down or chopped into a granola-like consistency and size. In other embodiments, the shredded root vegetable is processed to a grain-like consistency 1210 (FIG. 12). In other embodiments, the shredded root vegetable is processed to a flour or powder-like consistency (FIG. 7). Depending on the application, the shredded root vegetable can be even further processed, such as filtered or sifted.

For example, in some embodiments the invention relates to a food product comprising a flour or a powdered-like product of the dried and caramelized root vegetable. FIG. 7 is a photograph of a flour or a powdered-like product of the dried and caramelized root vegetable. The flour or powder 700, can be used, for example, as a supplement or food additive in drinks, such as sports drinks, smoothies, shakes, or other beverages. The flour or powder can also be used, for example, as a supplement or food additive in solid foods, such as snack bars or as any flour substitute.

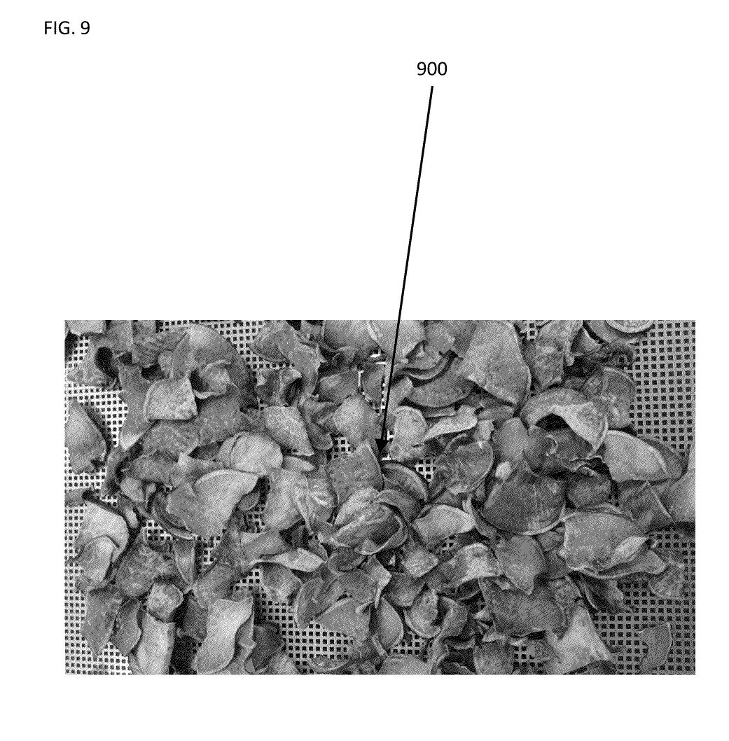

The root vegetable, e.g., sweet potato, can also be processed in other shapes and sizes. For example, FIG. 9 is a photograph of thinly sliced sweet potatoes that have been baked, and lightly oiled and/or salted. The thinly sliced sweet potatoes (e.g., in the form of potato chips) was baked at about 275° F. for about 40-50 minutes.

The food products described herein can be substantially allergen-free. In some embodiments, the food product is substantially gluten-free. “Gluten-free” refers to a food or food product that is substantially free of gluten. The food product can also be substantially nut-free. Nut-free refers to a food or food product that does not contain one or more peanuts or tree nuts, associated with an allergy or allergic reaction. For example, peanuts, almonds, Brazil nuts, walnuts, hazelnuts, macadamia nuts, pistachios, pecans, and cashews are common nut allergies.

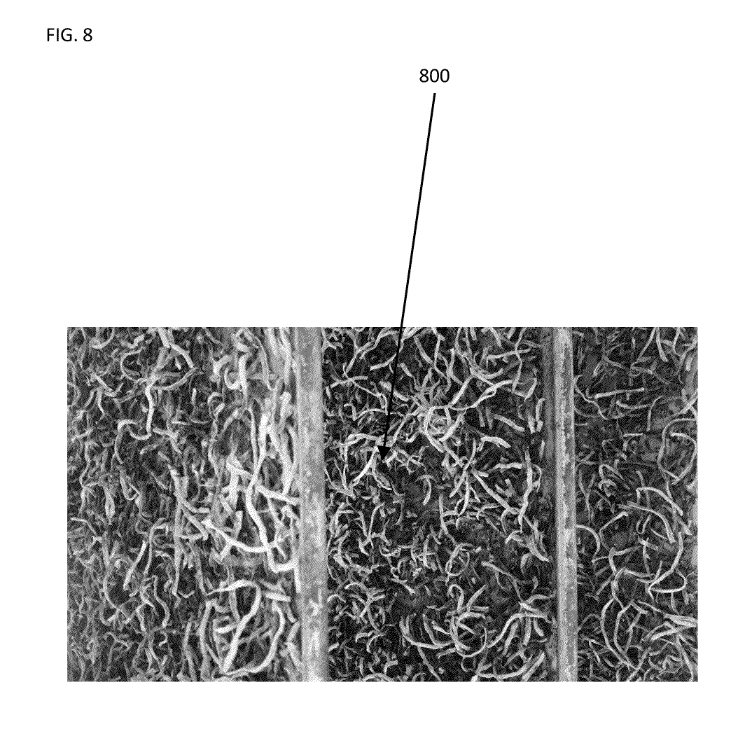

FIG. 8 is a photograph of shredded sweet potato after the following steps:

The shredded sweet potato was left out in open air (about 60° F. to about 75° F.) for approximately 9-15 hours. The oxidized shredded root vegetable was then moved to a room temperature (i.e., cold) oven which was then heated to approximately 265-285° F. The sweet potato was baked for approximately 20-35 minutes, and was rotated in the oven about half-way through the baking process. This resulted in a very dark brown to black color sweet potato 800 (FIG. 8).

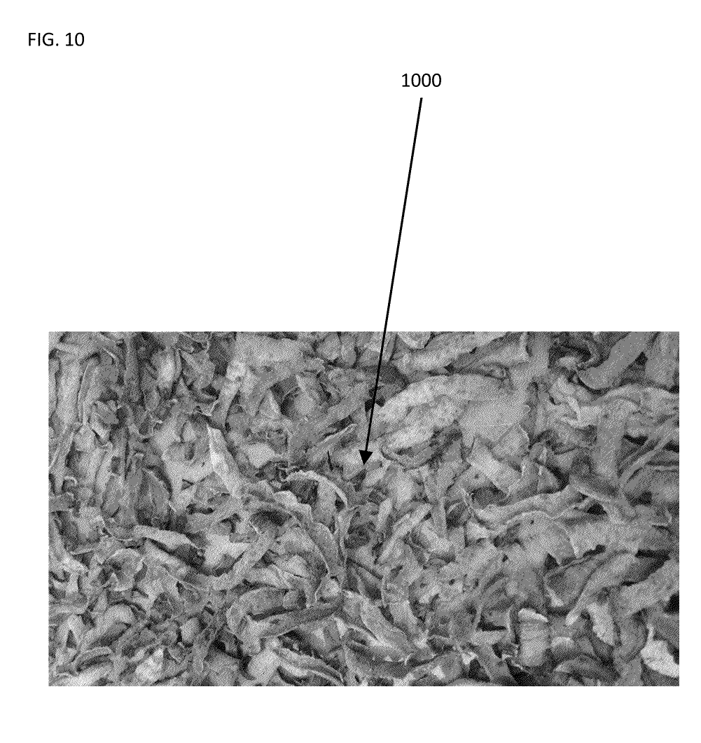

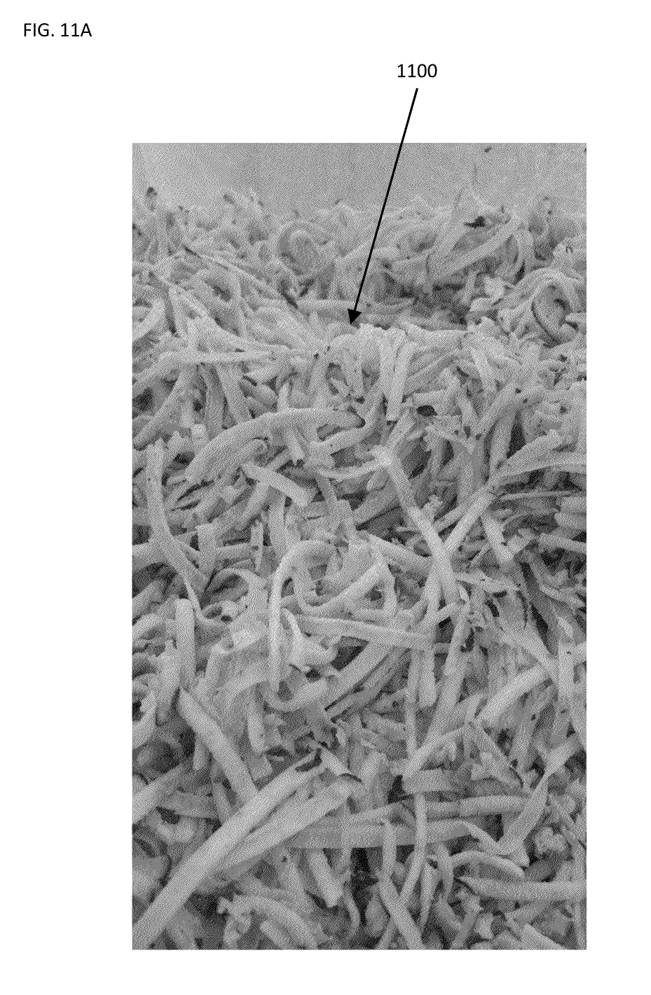

FIG. 10 is a photograph of shredded root vegetable 1000 which has been shredded using a shred plate containing holes approximately ½ inch in diameter. In some embodiments, the shredding plate used to shred the root vegetable contains holes that are approximately ¼ to ¾ inches in diameter, which is subsequently baked at approximately 265-285° F. for approximately 40-50 minutes, removed from oven and exposed to air to cool down.

A food preservative can be added to the food product to, for example, extend shelf-life. Examples of food preservatives include vitamin E oil and citric acid.

The food product can be packaged according to known methods. For example, the food product can be packaged using flexible packaging, glass jars, cans, bags, boxes, etc.

The following examples are provided for further illustration of various aspects of the present teachings, and are not necessarily intended to indicate optimal ways of practicing the invention.

### EXEMPLIFICATION

### Example 1

### Processing Sweet Potatoes for Food Production

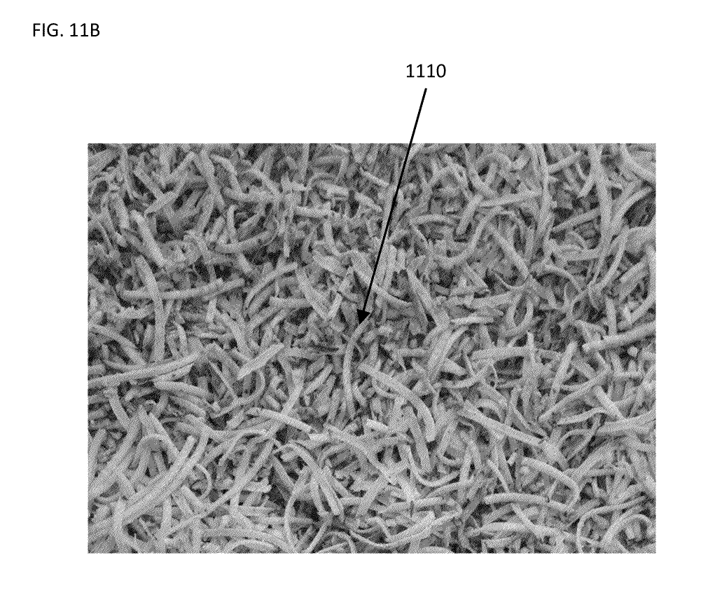

The sweet potatoes were washed following USDA guidelines for washing root vegetables. The sweet potatoes were then air-dried to remove most of the surface moisture from the skins. Undesirable material from the body was removed from the sweet potatoes, such as bruised portions or non-fleshy root strands (these excised portions contribute bitter flavor and a tough texture and can be hard on processing equipment). The sweet potatoes were passed through a shredding plate with hole-sizes of about 3/16 inch. The shredded root vegetable strands had approximate dimensions of about 3/16 inch wide, about 1/16 inch deep, and about 1 to about 3 inches in length. The length depended on the original shape of the sweet potato. The shredded sweet potato strands were protected from ambient exposure to heat and air (oxygen) by covering the shredded sweet potato, refrigerating the shredded sweet potato, or freezing the shredded sweet potato, depending on the production. FIG. 11A is a photograph of freshly shredded sweet potato 1100. FIG. 11B is a photograph of oxidized, shredded sweet potato 1110. Freshly shredded sweet potato strands 1100, quickly oxidize 1110, and can change flavor and produce a starchier end product.

### Example 2

### Cooking Sweet Potatoes

The shredded sweet potato strands were uniformly distributed on a baking sheet. The shredded strands were layered on top of each other, creating air pockets to help the drying process. On the baking sheet, the root vegetable strands formed a layer about ¼ inch to about 1 inch in depth. To compensate for the non-uniformity of blowing currents in a convection oven, the shredded strands were loaded slightly deeper around the edges. The heat in convection oven tends to curl around the edges of a sheet pan and therefore bake up more quickly than in center of the pan at a given temperature.

A convection oven was preheated to about 265° F. to about 275° F. for about 15 to about 30 minutes. Exterior conditions near the oven can affect oven performance and end results. Such ambient factors around the oven are monitored and the oven temperature was periodically adjusted throughout the process.

Baking sheets loaded with shredded root vegetable were placed in the oven. The space above, below, between, and on all sides of the sheets were from about 2 inches to about 7 inches.

The shredded sweet potatoes were exposed to (e.g., baked at) about 275° F. for about 20 to about 35 minutes (adjustments to both temperature and cooking time were sometimes made for changes in the ambient conditions exterior to the oven). The oven was run with the doors slightly ajar, leaving a gap of about ¼ inch to about 1 inch during the first 20 to 35 minutes of baking time. There was no adjustment made to the exposing temperature. The standard function of the convection compensates for the doors kept ajar and for differences in the ambient conditions around the heating devices exterior.

The ventilation around the oven was controlled during the baking process. For example, doorway openings, window openings, and multiple fans were used to modulate the flow of air. The removal of water (i.e., drying) from the root vegetables during the baking process was accompanied by releases of steam. The drying process varied by external factors such as air humidity (e.g., if raining), outside temperature (e.g., time of year), and elevation above sea level. The ambient temperature in the immediate vicinity of the heating device was maintained at about 60° F. to about 70° F., air humidity was less than 60%, ventilation was managed with circulation. Slowing the moisture loss during drying process results in a caramelized and sweet flavored product due to caramelizing, fermentation, oxidization, and/or the Maillard Reaction. Humidity of the ambient air (e.g., outside the oven), temperature of the ambient air, and length of bake time are important in production and results.

After about 20 to about 35 minutes of bake time, the oven was opened and the baking sheets were rotated as needed to maintain uniform baking. The baking sheets were rotated 180° front-to-back in the oven and the top sheet was exchanged with the second or third sheet. Additional baking time was determined and ranged from about 10 to about 20 minutes. The oven doors were kept slightly ajar during this time. The temperature was maintained at about 275° F. or adjusted for desired results.

The baking sheets were removed from the oven and placed on a cooling baker's rack. The cooling process was aided with additional direct air circulation on the cooling sheet pans in the rack. For example, the sheet pans were removed from the heating device to a cooling baker's rack, and a cooling floor fan quickly cooled the sheet pans at an upward angle from below.

FIG. 12 is photograph of baked and shredded sweet potato 1200. The cooled shredded baked strands 1200 were scraped from the sheet pans either into an airtight container as an ingredient for later use in the finished product. The baked strands were then chopped 1210 in a food processor and placed into an airtight container.

### Example 3

### Food Characteristics

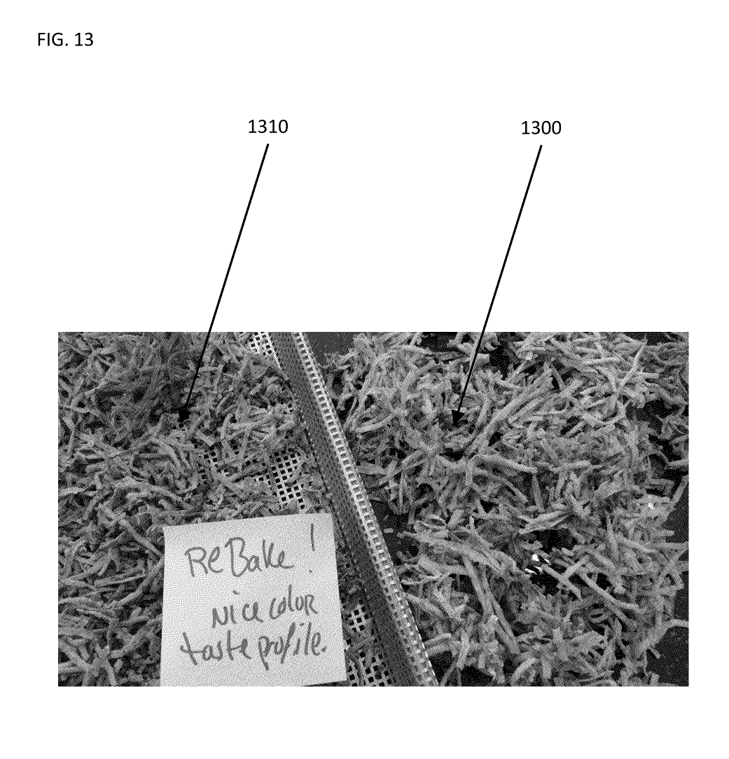

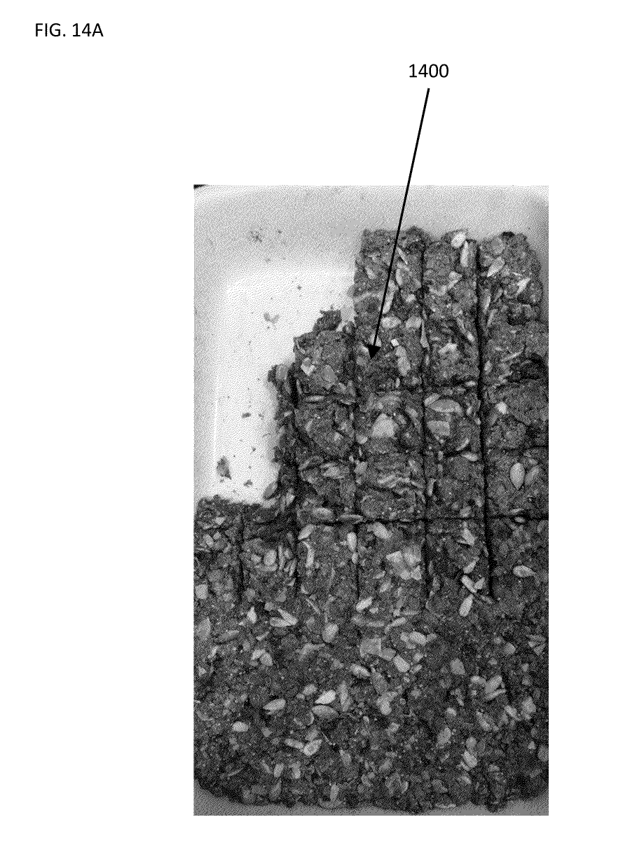

FIG. 13 is a photograph of the desired color of the resulting food product. The chopped, baked, shredded strands of sweet potato have a shelf life of at least 6 months and an expected shelf life of about one year or more. Shelf life can be controlled and extended by adding, for example, shelf-life extending agents such as vitamin E oil and/or citric acid. The finished sweet potato was slightly less than 2/16 inch in width while its length varied from small granular sizes to about 2 inches. It was evenly caramelized and has a density of about 1.1 g/ml. The color varied from light tan, beige (1300), or golden brown to a deep brown 1310. The sweet potato has an appealing caramel aroma and naturally sweet flavor. The texture is typically brittle and crunchy and keeps its texture in liquid for a longer than an average period of time for a cereal or grain.

### Example 4

### Original Food Product

TABLE 2
Ingredients in Original Food Product

| Ingredient | Quantity | |
|---|---|---|
| dried sweet potatoes | 52 | oz. (dry) |
| sunflower seeds | 32 | oz. (dry) |
| pumpkin seeds | 16 | oz. (dry) |
| coconut chips | 12 | oz. (dry) |
| coconut sugar | 1 | oz. (dry) |
| salt | .07 | oz. (dry) |
| stevia | 6 | tsp. |
| sunflower oil | 1.8 | ounce (fl.) |
| agave syrup | 8 | ounce (fl.) |
| dried fruit | 16 | oz. (dry) |
| flavored oil | 1.5 | oz. (ft.) |

| | |
|---|---|
| additional seasonings | varies |

Each of the following ingredients from Table 2 were weighed and mixed: dried sweet potatoes, sunflower seeds, pumpkin seeds, coconut chips, coconut sugar, salt, and stevia. The mixture was mixed thoroughly for about 10 minutes. The food mixer was stopped and the following wet ingredients from Table 2 were added in order listed: sunflower oil and agave syrup. This was mixed for about 15 minutes. The food mixer was stopped and the mixture was manually blended for even coating. The food mixer was run for another 5 minutes until blended uniformly. The mixture was distributed among ten full size baking sheet pans and baked in a preheated convection oven for about 10 to about 12 minutes or until evenly toasted at approximately 265° F.-275° F. The sheet pans were removed and cooled fully before adding to storage containers.

Nutrition Facts: Serv. Size: ⅔ cup, Calories 170 kcal (energy), Total Fat 12 g, Sat. Fat 3 g, Trans. Fat 0 g, Polyunsaturated Fat 4 g, Monounsaturated Fat 4 g, Sodium 105 mg, Total Carb. 11 g, Fiber 4 g, Sugar 5 g, Added Sugar<1 g, Protein 5 g.

### Example 5

### Cranberry Lemon

The steps for producing the original (base) food product is described above in Example 4. In a container, about 7 lbs. of cooled base recipe was weighed. Fruit and flavored oil were added to the cooled base recipe in a food mixer. The mixture was mixed for about 10 minutes and then was manually blended as needed. The mixture was mixed for another 5 minutes until blended uniformly.

Nutrition Facts: Serv. Size: ⅔ cup, Calories 190 kcal (energy), Total Fat 12 g, Sat. Fat 3 g, Trans. Fat 0 g, Polyunsaturated Fat 4 g, Monounsaturated Fat 4 g, Sodium 105 mg, Total Carb. 15 g, Fiber 4 g, Sugar 9 g, Added Sugar<1 g, Protein 5 g.

### Example 6

### Raisin

The steps for producing the original (base) food product is described above in Example 4. In a container, about 7 lbs. of cooled base recipe was weighed and raisins were added to a food mixer. The mixture was mixed for about 10 minutes and then was manually blended as needed. The mixture was mixed for another 5 minutes until blended uniformly.

Nutrition Facts: Serv. Size: ⅔ cup, Calories 190 kcal (energy), Total Fat 12 g, Sat. Fat 3 g, Trans. Fat 0 g, Polyunsaturated Fat 4 g, Monounsaturated Fat 4 g, Sodium 105 mg, Total Carb. 16 g, Fiber 4 g, Sugar 8 g, Added Sugar<1 g, Protein 5 g.

### Example 7

### Orange Spice

The steps for producing the original (base) food product is described above in Example 4. In a container, about 7 lbs. of cooled base recipe was weighed and added to a food mixer along with additional seasonings, comprising about 3 teaspoons each of nutmeg and allspice. The mixture was mixed for about 10 minutes and then was manually blended as needed. The mixture was mixed for another 5 minutes until blended uniformly. Fruit and flavored oil were then added and mixed for about 10 minutes and then was manually blended as needed. The mixture was mixed for another 5 minutes until blended uniformly.

Nutrition Facts: Serv. Size: ⅔ cup, Calories 190 kcal (energy), Total Fat 12 g, Sat. Fat 3 g, Trans. Fat 0 g, Polyunsaturated Fat 4 g, Monounsaturated Fat 4 g, Sodium 105 mg, Total Carb. 16 g, Fiber 4 g, Sugar 8 g, Added Sugar<1 g, Protein 5 g.

### Example 8

### Bars & Muffins

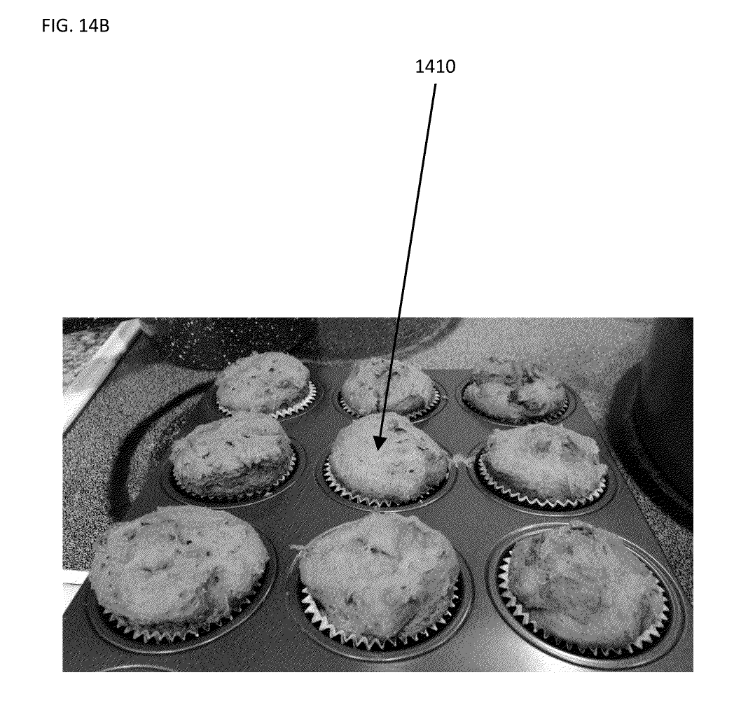

FIGS. 14A-B are photographs of the base food product in bar and muffin form. The steps for producing the original (base) food product is described above in Example 4, but also including 3.5 oz. of sweet potato flour 1200, twice milled; 10 oz. agave syrup; 1 oz. of vanilla; and 4 oz. cereal mix added. In a container, about 7 lbs. of cooled base recipe was weighed and added to a food mixer along with additional seasonings, comprising about 3 teaspoons each of nutmeg and allspice. The mixture was mixed for about 10 minutes and then was manually blended, as needed. The mixture was mixed for another 5 minutes until blended uniformly. Fruit and flavored oil were then added and mixed for about 10 minutes and then was manually blended, as needed. The mixture was mixed for another 5 minutes until blended uniformly. The mixture is then baked at approximately 340-360° F. for approximately 20-30 minutes, and removed from the oven to cool and shaped into a bar 1400 or muffin 1410.

### Example 9

### Sweet Potato Chips

Sweet potatoes were thinly sliced and baked at about 275° F. for about 45 minutes. The chips were cooled and tossed with a small amount of salt and oil. See FIG. 9.

### Example 10

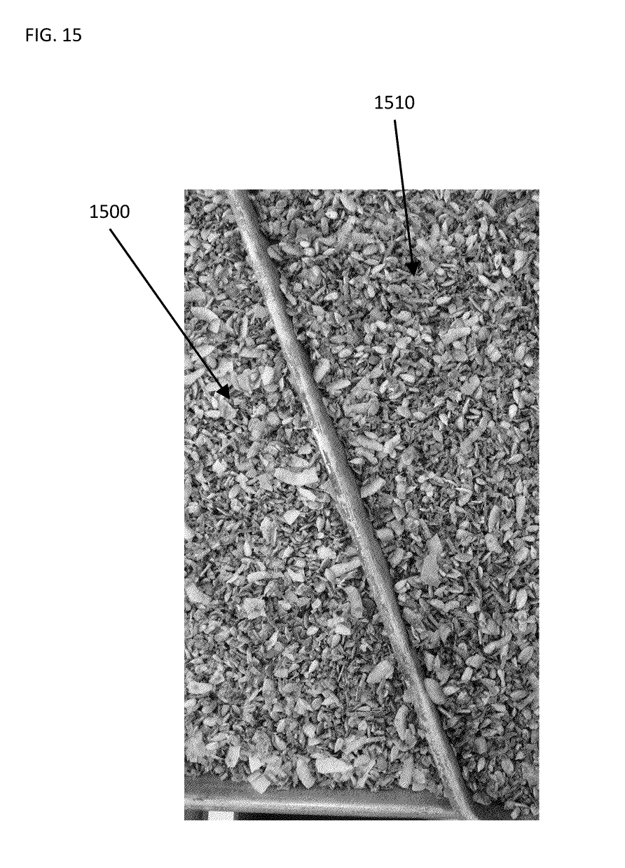

The embodiments and examples provided herein provide a food product that comprises dried caramelized sweet potato pieces, seeds and coconut flakes to achieve a very crunchy, slightly sweet, granola-type consistency with an earthy tan, white, green and brown colors. In some embodiments, dried fruit and/or flavored oils were added to some of final product flavors. FIG. 15 is a photograph of the food product in cereal form. The uncooked food product 1500 is shown next to cooked product 1510. The cooked food product 1510 can be used as a cereal, with milk, as a granola, or as a snack. Additionally, it may be added to yogurt or heated with milk to create a hot cereal.

Also, the food products described herein are substantially free from eight common allergens: milk, egg, wheat, soy, fish, shellfish, peanuts, and tree nuts. In addition, gluten is not added to these food products. Special care goes into the production of such free-from foods, e.g., an allergen control plan, frequent testing of incoming ingredients, of intermediate products and of all final products during each stage of production, sanitization protocols, special uniforms and employee procedures during food breaks.

The relevant teachings of all patents, published patent applications and literature references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for producing a food product comprising the steps of:
shredding a root vegetable;
exposing the shredded root vegetable to a heated environment of about 250° F. to about 300° F. for a sufficient time to allow the shredded root vegetable to dry, caramelize, or both;
cooling the dried, shredded root vegetable to about room temperature; and
combining the cooled, dried, shredded root vegetable with one or more seeds, coconut, salt or combinations thereof to form a food product.

2. The method of claim 1, wherein the root vegetable is a monocotyledon, a dicotyledon, or a combination thereof.

3. The method of claim 2, wherein the monocotyledon is a yam.

4. The method of claim 2, wherein the dicotyledon is a sweet potato.

5. The method of claim 4, wherein the sweet potato is a Murasaki sweet potato.

6. The method of claim 1, wherein the dried root vegetable has a density of about 0.5 to about 1.5 g/ml.

7. The method of claim 1, further comprising combining the cooled, dried, shredded root vegetable with one or more sugar or sugar substitutes, wherein the one or more sugar or sugar substitutes is selected from the group consisting of stevia, agave syrup, and coconut sugar.

8. The method of claim 1, further comprising combining the cooled, dried, shredded root vegetable with one or more oils.

9. The method of claim 8, wherein the one or more oils is a sunflower oil.

10. The method of claim 1, wherein the one or more seeds is a sunflower seed, a pumpkin seed, or a combination thereof.

11. The method of claim 1, further comprising combining the cooled, dried, shredded root vegetable with one or more dried fruits.

12. The method of claim 11, wherein the dried fruit is a cranberry, a raisin, or a combination thereof.

13. The method of claim 1, further comprising combining the cooled, dried, shredded root vegetable with a chocolate.

14. The method of claim 1, further comprising combining the cooled, dried, shredded root vegetable with a shelf-life extending agent selected from the group consisting of vitamin E oil and citric acid.

15. The method of claim 1, wherein shredding the root vegetable comprises passing the root vegetable through a shredding plate, wherein the shredding plate comprises one or more holes from about ⅙ inch to about ½ inch in diameter.

16. The method of claim 15, further comprising layering the shredded root vegetable about ⅛ inch to about 1 inch on a baking sheet prior to the exposing step.

17. The method of claim 1, further comprising allowing air at about room temperature to mix with the heated environment during the exposing step.

18. A food product prepared according to the method of claim 1.

19. The food product of claim 18, wherein the food product is substantially gluten-free and/or nut-free.

20. The food product of claim 19, wherein the food product is packaged.
